(19) United States
(12) Patent Application Publication
(10) Pub. No.: US 2017/0213498 A1
(43) Pub. Date: Jul. 27, 2017

(54) A device with an art showing function

(71) Applicant: WHAT WATCH AG, Zürich (CH)

(72) Inventors: Igor Basargin, Ekaterinburg (RU); Masashi Kawamura, Tokyo (JP)

(73) Assignee: WHAT WATCH AG, Zürich (CH)

(21) Appl. No.: 15/328,075

(22) PCT Filed: Jul. 23, 2014
(86) PCT No.: PCT/IB2014/063342

§ 371 Date: Jan. 23, 2017

(51) Int. Cl. G09G 3/20

(52) U.S. Cl. CPC G09G 3/2092; G04G 9/0064

(57) ABSTRACT

“A wearable device, such as a wristband device with an art showing function, comprises a data communication device for receiving art data and a display device. In addition the device comprises also a data processing and controlling unit, which is configured to instruct said display device to show said art based on said received art data.”

### TECHNICAL FIELD OF THE INVENTION

The invention relates to a device provided with an art showing function.

### BACKGROUND OF THE INVENTION

It is commonly known to use different kinds of ornaments, such as bracelets, necklaces or belts with printed art. However the printed or otherwise fixed art is quite stationary and if one would like to change the printed art, she should change the whole ornament. Additionally also devices, such as mobile phones and smartphones are known with changeable covers as well as screen savers or background screens types of changing figures in their displays are known. Anyhow these kinds of devices are typically kept in pockets or handbags, whereupon the changing figures or other arts shown cannot be seen. In addition these devices are very bulky for art showing function.

### SUMMARY OF THE INVENTION

An object of the invention is to alleviate and eliminate the problems relating to the known prior art. Especially the object of the invention is to provide a device, which is easy to use and by which any kinds of arts can be shown easily and in a convenient way.

The object of the invention can be achieved by the features of independent claims.

The invention relates to a device with an art showing function according to claim 1. In addition the invention relates to a method for providing the device with an art showing function according to claim 19.

According to an embodiment of the invention a device with an art showing function comprises a data communication device for receiving art data from an art data generator of the wearable device, or from an outer device having an art data generator according to the certain algorithm(s). The device with an art showing function comprises a display device, and is advantageously a wearable device, such as e.g. a bracelet, necklace, belt, wristband or the like. The outer device is for example a wireless terminal, such as mobile phone, smartphone, tablet computer, laptop computer, computer, router, WiFi/Bluetooth access point or router, server or cloud based server, or base station. The art data may comprise still, slide-show type, animated or video image data or any combination of above.

The art data may be generated in pre-hand by an outer device, such as a server or cloud server, and the art data may be preloaded in the wearable device. According to an embodiment the art data may be generated e.g. real-time by the data processing and controlling means of the wearable device. The art data can be generated for example by using a computation algorithm and by combining certain time-stamp and pre-defined art data, for example. It is to be noted that the algorithm may use the pre-defined art data and the time-stamp data, such as current time and/or measured physical quantity data or data derived from the time-stamp and/or measured physical quantity data, as a seed data and thereby generate the art data to be shown. Thus the art may be very changeable and unique. Also other examples are discussed in this document.

The wearable device comprises also a data processing and controlling unit to instruct the display device to show the art based on said received art data. According to an advantageous embodiment the wearable device may be as a wristwatch but not necessary showing time in regular manner. The time can be shown for example by artwork corresponding to a certain time of the day. Display device can also show the combination of the time showing and the art data. The data processing and controlling unit may also process the input data according to certain time based algorithm and thereby show artwork corresponding to said algorithm.

The data communication device is most advantageously implemented by a wireless technology, such as Bluetooth, WIFI, 3G/4G, NFC, infrared or visible, or optical communication between the device and the outer device. However it is to be noted that also a wired data communication system can be used.

The display device is advantageously a 2D image, 3D image or 2D/3D video showing display, and may be implemented for example by an electrophoretic ink paper display, which is very energy efficient technology, or monochromatic display, grey-scale display, a reflective, transflective or transmissive TFT based display (Thin-Film-Transistor display) or an OLED (Organic Light-Emitting Diode), or microelectromechanical systems (MEMS) display comprising e.g. a mirror structure or relief structure controlled via an electromagnetic technique, for example or a projector. In addition also the display device may also be implemented by a capacitive touch screen. According to an exemplary embodiment the display device may also be a 3D image or video showing display, such as display device configured to provide a 3D relief type of art by means of electromechanically controlled elongated members (to create the relief).

According to an embodiment the display device is as a reflective display device comprising microscopic mirrors (“MEMS”) in each pixel changing the size of an air gap inside the display so that depending on the size of the gap, white light is reflected back as red, green or blue, for example. The reflective display is based on interferometric modulation, where each pixel comprises sub-pixels, and where each sub-pixel mirror opens to only one colour stage, whereupon the colour of the pixel is combination of colours of sub-pixels.

According to an embodiment the wearable device comprises at the use (advantageously downloaded via the wireless way) plurality of art to be shown. The wearable device may thus be configured to change the art shown using a certain predetermined logic, such as when manipulating a user interface, like pressing a button or after a certain time elapsed or according to certain time stamp, where time stamp may be created by an end-user or created randomly according to pre-set algorithm and initiated by the end-used through the user interface on the wearable device or the outer device.

The wearable device may comprise a user interface or the like, such as a mechanical button, proximity sensor or a control wheel for example around the display, whereupon the wearable device is configured to change the art shown, when the user interface is manipulated, such as when said button is manipulated or the control wheel is turned. The wearable device may also comprise a sensor for measuring a physical quantity, whereupon the wearable device is advantageously configured to change the art shown, when the determined quantity exceeds or deseeds a certain predetermined limit. The sensor may comprise for example a temperature sensor, acceleration sensor, gyroscope, location sensor, altimeter, barometer, or speed indicator, a physiological signal measuring device, such as heart rate monitor or blood pressure monitor. Thus the wearable device may change the art shown e.g. when temperature exceeds or deseeds a certain limit, for example if the device is shaken or a predetermined motion is done, when acceleration exceeds or deseeds a certain limit, when a certain location or altitude or speed is reached, when a physiological signal, such as heart rate or blood pressure exceeds or deseeds a certain limit, as an example.

In addition the display device may also be implemented by a capacitive touch screen as an interactive display, whereupon for example a time stamp may be activated via manipulating said capacitive touch screen.

The wearable device comprises also an energy source for feeding energy to the display, sensors and data processing units, for example. The energy source may comprise e.g. a primary (non-rechargeable) battery or a chargeable battery, super-capacitor or any energy harvesting device for harvesting energy from motion, such as harvest energy from hand movement wearing the wristwatch device, temperature difference and solar energy, for example, whereupon the wearable device is configured to powering the device and/or charge said battery or other energy storage via such harvesting device or their combination. Additionally the wearable device comprise may comprise an induction device to be coupled with an induction coil energy wireless charging system, whereupon the wearable device is configured to charge said battery via induction.

The present invention offers advantages over the know prior art, such as the possibility to provide a device, which is easy to use and by which any kinds of electrical form arts can be shown easily and in a convenient way. The wearable device according to invention offers an option for owning an own visual art piece on users wrist or neck, for example. One can purchase and create own designs and animations to keep on the watch like device, for instance. According to an embodiment the wearable device may advantageously has a flat surface built in full colour LCD display. In addition according to an embodiment the display device is covered with a similar surface texture as the belt to give it a seamless look.

Still according to an embodiment the time can be shown on the display when a user interface is manipulated, for example when a portion of the wearable device is pressed, such as pressing the upper part, and the bottom part may turn on and off the animation. Also other gestures or manipulation of the user interfaces can be used for changing function of the wearable device, such as showing different data on the display. According to an example the time will be indicated over the animation or art, when the button on the side of the device is pressed or other user interface means is manipulated. The time will stay on the display for a moment, such as 10, 20 or 30 seconds for example, and thereby disappear.

Furthermore according to an embodiment also an application and thereby a possibility is provided, where the users can upload or create their own art to be displayed by the wearable device of the invention. The art can be uploaded for example to the memory of the device, outer device or server or database, where it can be received by the user or certain users belonging to a pre-defined group or all the users.

The invention offers a possibility to upload or purchase and download favourite visuals and motion graphics onto the wearable device for example via website browser. According to an embodiment one can visit for example physical stores to see all the different animations for real on display and purchase limited editions. In addition according to an example once the user buys the wearable device, he might be asked to create an own page on the service provide website, where people can browse through their own and possible also friends' and artists' work, and also check FAQs and receive customer support. According to an example there might also be an artist page on the site where people can browse and purchase art based on who the artist is. Search can be done e.g. by name of the artist or by the title of work.

### BRIEF DESCRIPTION OF THE DRAWINGS

Next the invention will be described in greater detail with reference to exemplary embodiments in accordance with the accompanying drawings, in which:

FIG. 1 illustrates a principle of a wearable device with an art showing function according to an advantageous embodiment of the invention,

FIGS. 2A-2B illustrate exemplary wearable wristband devices according to an advantageous embodiment of the invention, and

FIGS. 3A-3H illustrate exemplary wearable wristband devices with art or other data showing property according to an advantageous embodiment of the invention.

### DETAILED DESCRIPTION

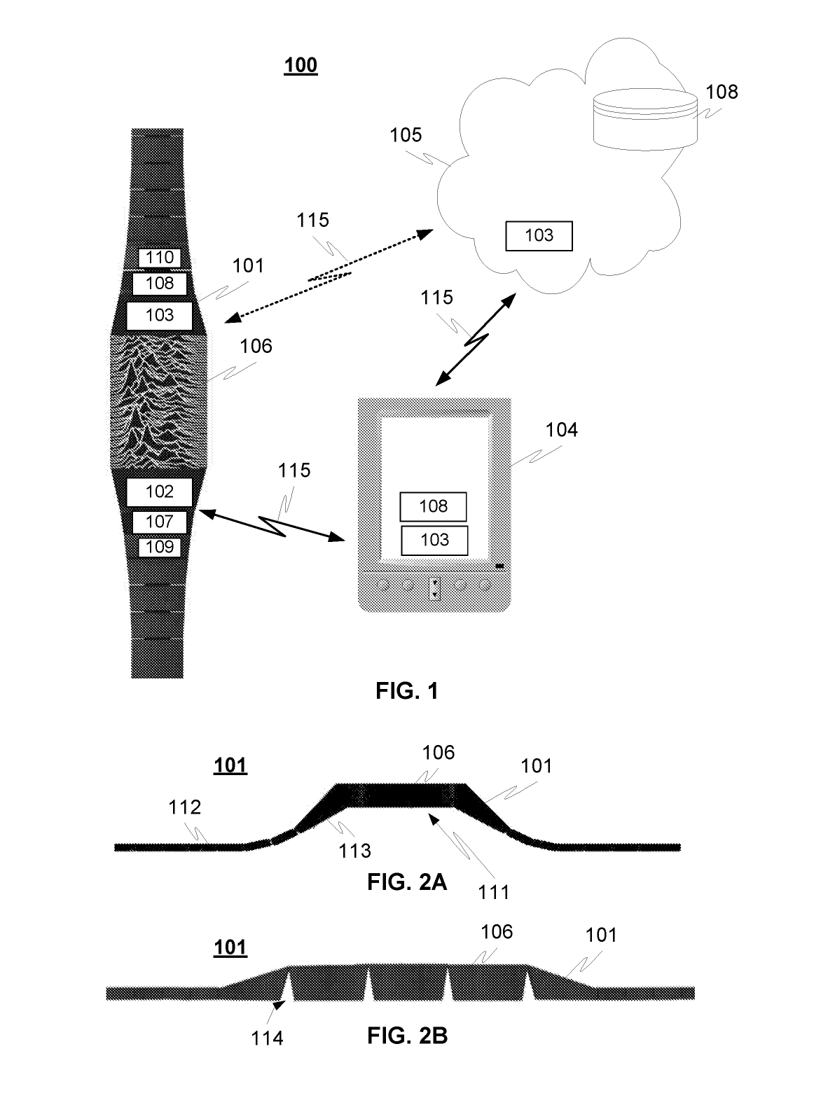

FIG. 1 illustrates a principle of a wearable device system 100 with an art showing function according to an advantageous embodiment of the invention, wherein the system comprises a device 101, such as a wristwatch like device, with an art showing function. The system 100 comprises a data communication device 102 for receiving 115 art data from an art data generator 103 of the wearable device 101, or from an outer device 104, 105 having an art data generator 103. The device 101 with an art showing function comprises a display device 106, and is advantageously a wearable device, such as e.g. a bracelet, necklace, belt, wristband or the like. The outer device 104, 105 is for example a wireless terminal, such as mobile phone, smartphone, tablet computer, laptop computer, computer, router, server or cloud based server, or base station with suitable memory devices, such as a database 108.

The data communication link 115 may be a single or bi-directional data communication link 115 and is advantageously established between the wearable device and the first near outer device 104, such as device bring by the user, for example a smart phone 104. Additionally the smart phone 104 may establish additional data communication link 115 with another outer device, such as network cloud server 105. It is to be noted that the wearable device 101 may also establish (optionally) direct data communication link 115 via the router to the server 105 or the like.

The art data may be generated e.g. real-time by the data processing and controlling device 107 of the wearable device. The data processing and controlling device 107 may also be used to instruct the display device to show the art based on said received art data. The data processing and controlling device 107 may also process the input data according to certain time based algorithm and thereby show artwork corresponding to said algorithm.

The wearable device 100 may comprise a user interface or the like 109, such as a mechanical button, proximity sensor or a control wheel or a sensor for determining physical quantity, as described elsewhere in this document. The user interface 109 and the data processing and controlling device 107 are advantageously functionally coupled so to change the art shown, when the user interface 109 is manipulated, such as when the button is manipulated, the control wheel is turned or when the physical quantity determined by the sensor exceeds or deseeds a certain limit.

The wearable device 101 comprises also an energy source 110 for feeding energy to the display 106, user interface 109 and sensors, data communication device 102 and data processing and controlling devices 107, for example. The energy source may comprise e.g. a primary (non-rechargeable) battery or a chargeable battery, energy harvesting device, or an induction device to be coupled with an induction coil energy charging device, or the energy source may be a combination of the aforementioned devices.

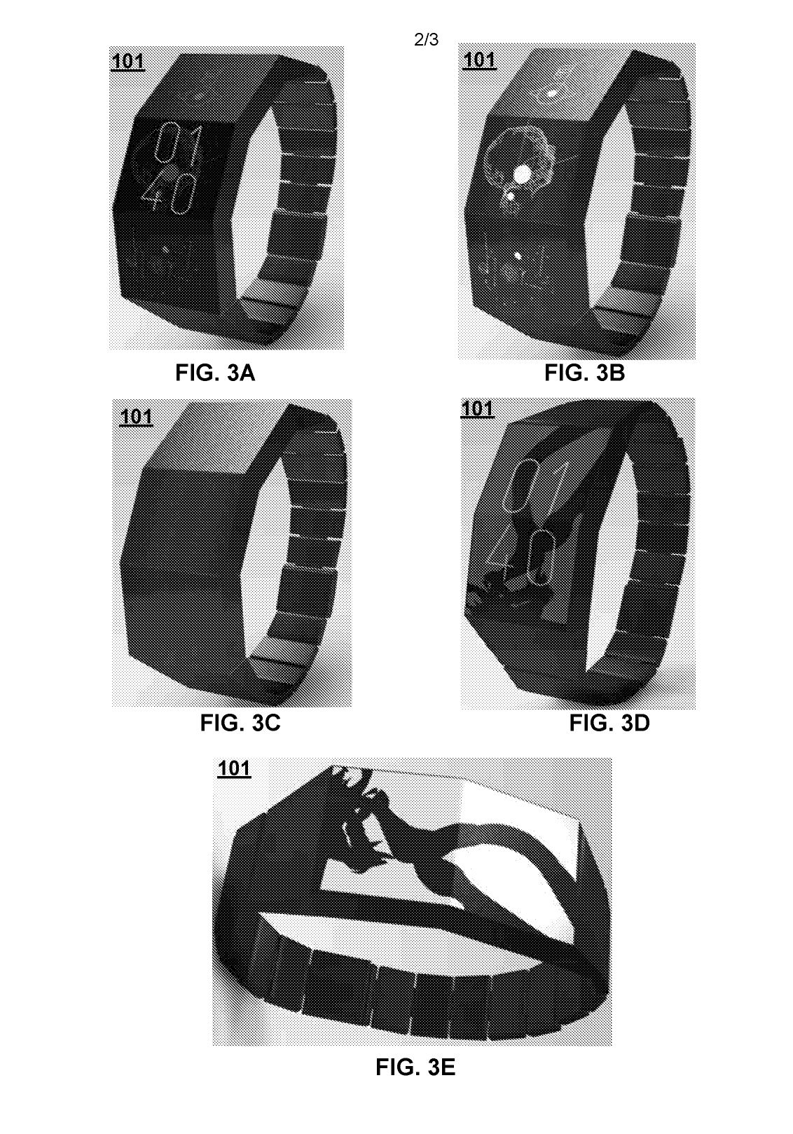

FIGS. 2A and 2B illustrate an exemplary wearable wristband devices 101 according to an advantageous embodiment of the invention, wherein the wearable wristband devices 101 in FIG. 2A comprises essentially a planar or flat base structure 111, whereupon the display device 106 is also as a planar or flat display device. The flat surface might comprise e.g. in full colour LCD display 106, and the display device 106 is advantageously covered with a similar surface texture as the belt 112 to give it a seamless look. In addition the wristband device 101 comprises slanted edges 113 for a better fit to the wrist.

According to an embodiment the whole side of the wristband device 101 may be press-able, and will trigger the different mode based on where it is presses, i.e. time display to show on screen when the upper part is pressed, and the bottom part will turn on/off the animation, for example. The opposite side can also be used as buttons depending on functions to be provided.

FIG. 2B illustrates an exemplary wearable wristband devices 101, where the base structure of the wristband device comprises cavities or hole constructions 114 to provide a hinge design so that the wristband device 101 with larger display device area 106 is better fitted to the wrist. The larger display device area 106 may comprise plurality of display devices, such as for example two or more LCD displays to create a larger vertical display area.

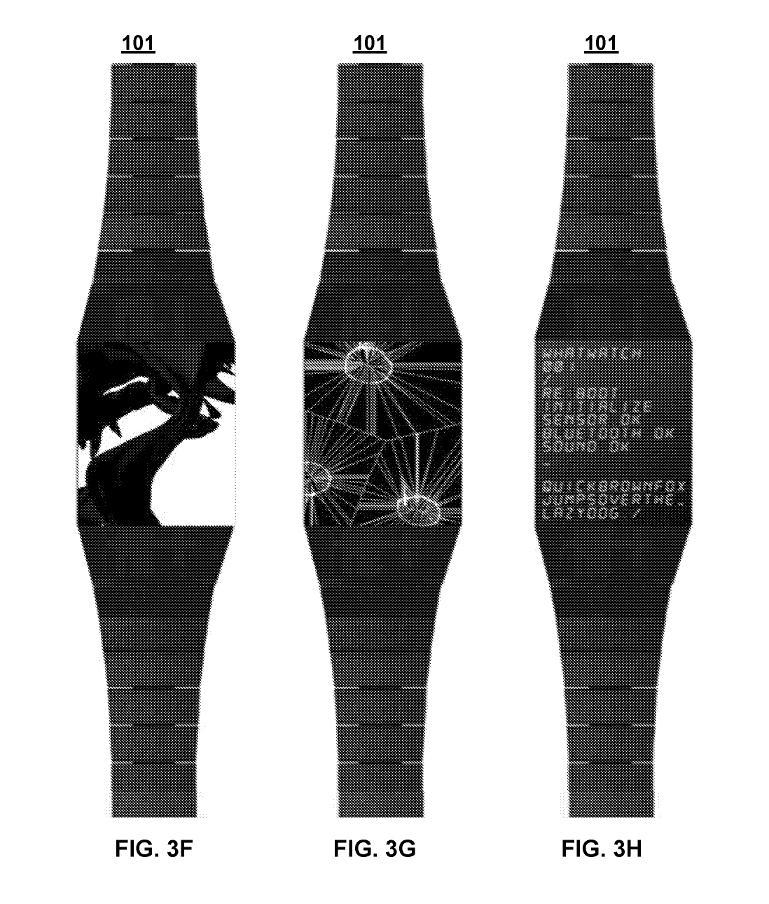

FIGS. 3A-3H illustrate exemplary wearable wristband devices 101 with art or other data showing property according to an advantageous embodiment of the invention.

It is to be noted that the data processing and controlling devices 107 and other properties of the device 101 for receiving, managing, processing and showing the art data and instructing the display device to show said art based on said received art data, can be implemented at least partly by a computer program product with suitable computer program code means, which can be run on said wearable device. The computer program product may also be configured to generate and provide said art data.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims. Especially it is to be noted that even if the wristband device is described as an example of the wearable device, the inventive concept described in this document can also be applied with other kinds of wearable devices, such as e.g. a bracelet, necklace, belt, wristband or even garments.

1. A device with an art showing function,
wherein said device is a wearable device, and wherein the wearable device comprises:
a data communication device for receiving art data;
a display device; and
a data processing and controlling unit, which is configured to instruct said display device to show said art based on said received art data.

2. The wearable device of claim 1, wherein the wearable device comprises an art data generator for generating said art data.

3. The wearable device of claim 1, wherein an outer device comprises an art data generator for generating said art data, whereupon the wearable device comprises a wireless or wired data communication device for receiving art data from said outer device.

4. The wearable device of claim 3, wherein the outer device is one of the following: wireless terminal, such as mobile phone, tablet computer, laptop computer, computer, router, server or cloud based server, or base station, and wherein the art data comprises still, slide-show type, animated or video image data.

5. The wearable device of claim 1, wherein said wearable device is a bracelet, necklace, belt or wristband device.

6. The wearable device of claim 1, wherein said data processing and controlling unit is configured to process received art data to be shown according to certain time based algorithm.

7. The wearable device of claim 1, wherein the data communication device comprises Bluetooth, WIFI, 3G/4G, infrared or visible optical communication; or wired data communication device configured to establish a data communication link between said wristwatch device and the outer device.

8. The wearable device of claim 1, wherein the wearable device comprises plurality of art to be shown, and whereupon said wearable device is configured to change the art shown after a certain time elapsed or according to certain time stamp, where time stamp is created by end-user or created randomly according to pre-set algorithm and initiated by the end-used through the user interface on the wristwatch device or the outer device.

9. The wearable device of claim 1, wherein the wearable device comprises a mechanical button or a proximity sensor, whereupon the wearable device is configured to change the art shown, when said button is manipulated or said proximity sensor outputs a signal in relation to a proximity determination.

10. The wearable device of claim 1, wherein the wearable device comprises a sensor measuring a physical quantity, the sensor comprising temperature sensor, acceleration sensor, location sensor, altimeter, barometer, or speed indicator, a physiological signal measuring device, heart rate monitor or blood pressure monitor and whereupon the wearable device is configured to change the art shown, when the determined quantity exceeds or deseeds a certain predetermined limit.

11. The wearable device of claim 1, wherein the wearable device comprises a control wheel around the display, whereupon the wearable device is configured to change the art shown, when the control wheel is turned.

12. The wearable device of claim 1, wherein the display device comprises an electrophoretic ink paper display, monochromatic display, grey-scale display, a reflective, transflective or transmissive TFT based display (Thin-Film-Transistor display), or OLED (Organic Light-Emitting Diode), MEMS display or a reflective display device comprising microscopic mirrors in each pixel of the display configured to change a size of an air gap inside the pixel and thereby interferometrically modulate white light to reflect back as different colours depending on the size of said air gap.

13. The wearable device of claim 1, wherein the display device comprises a capacitive touch screen whereupon a time stamp is activated via manipulating said capacitive touch screen.

14. The wearable device of claim 1, wherein said display device is configured to provide a 3D relief type of art by means of electromechanically controlled elongated members to create the relief.

15. The wearable device of claim 1, wherein the wearable device comprises a primary non-rechargeable battery or a chargeable battery and induction device configured to be coupled with an induction coil energy charging system, whereupon the wristwatch device is configured to charge said battery via induction.

16. The wearable device of claim 1, wherein said received art data is generated in pre-hand on an outer device, the outer device comprising a server or cloud server, and wherein said art data is configured to be preloaded in the wearable device.

17. The wearable device of claim 1, wherein said art data is generated real-time by the controlling means of the wearable device or in the outer device using computation algorithm and by combining certain time-stamp or measured physical quantity, and pre-defined art data.

18. The wearable device of claim 1, wherein said art data is generated real-time by the data processing and controlling means of the wearable device or by the outer device using computation algorithm and by combining certain time-stamp and pre-defined art data.

19. A method for providing a wearable device with an art showing function,
wherein the method comprises:
receiving art data by a data communication device from an outer device for the wearable device, and
controlling by a data controlling unit a display device of the wearable device to show said art based on said received art data.

20. (canceled)
